(19) United States
(12) Patent Application Publication
(10) Pub. No.: US 2017/0262208 A1
(43) Pub. Date: Sep. 14, 2017

(54) MEMORY DEVICE, HOST DEVICE, AND INFORMATION PROCESSING DEVICE

(71) Applicant: KABUSHIKI KAISHA TOSHIBA, Minato-ku (JP)

(72) Inventors: Chiyuan CHOOI, Meguro (JP); Nobuhiro KONDO, Yokohama (JP); Yaotung KUO, Shinagawa (JP); Kenji FUNAOKA, Kawasaki (JP)

(73) Assignee: KABUSHIKI KAISHA TOSHIBA, Minato-ku (JP)

(21) Appl. No.: 15/257,586

(22) Filed: Sep. 6, 2016

Related U.S. Application Data
(60) Provisional application No. 62/305,168, filed on Mar. 8, 2016.

(51) Int. Cl. G06F 3/06; G06F 1/32

(52) U.S. Cl. CPC G06F 3/0625; G06F 3/0632; G06F 3/0634; G06F 3/0659; G06F 3/0688; G06F 1/3296

(57) ABSTRACT

According to one embodiment, a memory device includes a second memory and a controller circuit. Power supply to the memory device is stopped in a second state. Internal data of the controller circuit is saved in a first memory of a host device in the second state. The controller circuit acquires information indicating resuming from the second state from the host device to perform a process of making the memory device transition from the second state to the first state.

### CROSS-REFERENCE TO RELATED APPLICATIONS

This application is based upon and claims the benefit of priority from U.S. Provisional Application No. 62/305,168, filed on Mar. 8, 2016; the entire contents of which are incorporated herein by reference.

### FIELD

Embodiments described herein relate generally to a memory device, a host device, and an information processing device.

### BACKGROUND

A UMA (Unified Memory Architecture) is a memory architecture in which the main memory in the host is shared between the host and device. In the case where the device is requested to reduce power consumption by transitioning into sleep mode, the device is required to store its pre-sleep conditions into its non-volatile memory. As for the memory device, it is desired to achieve a reduction in power consumption without degrading the lifetime of the non-volatile memory.

### BRIEF DESCRIPTION OF THE DRAWINGS

FIG. 1 is a diagram illustrating a basic configuration of an information processing device as described in the first embodiment;

FIG. 2 is an explanatory diagram of an example of a state transition of a memory device;

FIG. 3 is a diagram illustrating an operation example of the information processing device in the case of the memory device transitioning from active mode to 0-mW sleep mode;

FIG. 4 is a diagram illustrating an operation example of the information processing device in the case of the memory device transitioning from 0-mW sleep mode to active mode;

FIG. 5 is a flowchart illustrating an operation procedure of the memory device when the memory device transitions to 0-mW sleep mode;

FIG. 6 is a flowchart illustrating an operation procedure of the memory device when a resume request is issued;

FIG. 7 is a diagram illustrating an operation example of an information processing device described in the third embodiment where the memory device transitions from 0-mW sleep mode to active mode;

FIG. 8 is a flowchart illustrating an operation procedure of the memory device when a resume request is issued;

FIG. 9 is a diagram illustrating an operation example of an information processing device described in the fourth embodiment where the memory device transitions from 0-mW sleep mode to active mode; and

FIG. 10 is a flowchart illustrating an operation procedure of the memory device when a resume request is issued.

### DETAILED DESCRIPTION

In general, as described in the first embodiment, a memory device can be connected to a host device. The host device includes a main memory. The memory device includes a second memory and a controller circuit. The second memory is a non-volatile memory. The controller circuit performs a first process and a second process. The first process is a process of initializing the memory device and making the memory device transition to the first state. The second process is a process of making the memory device transition from the second state to the first state. Power supply to the memory device is stopped in the second state. Internal data of the controller circuit is saved in the second state in the main memory. The controller circuit acquires information indicating resuming from the second state from the host device, to perform the second process.

Exemplary embodiments of a memory device, a host device, and an information processing device will be explained below in detail with reference to the accompanying drawings. The present invention is not limited to the following embodiments.

### First Embodiment

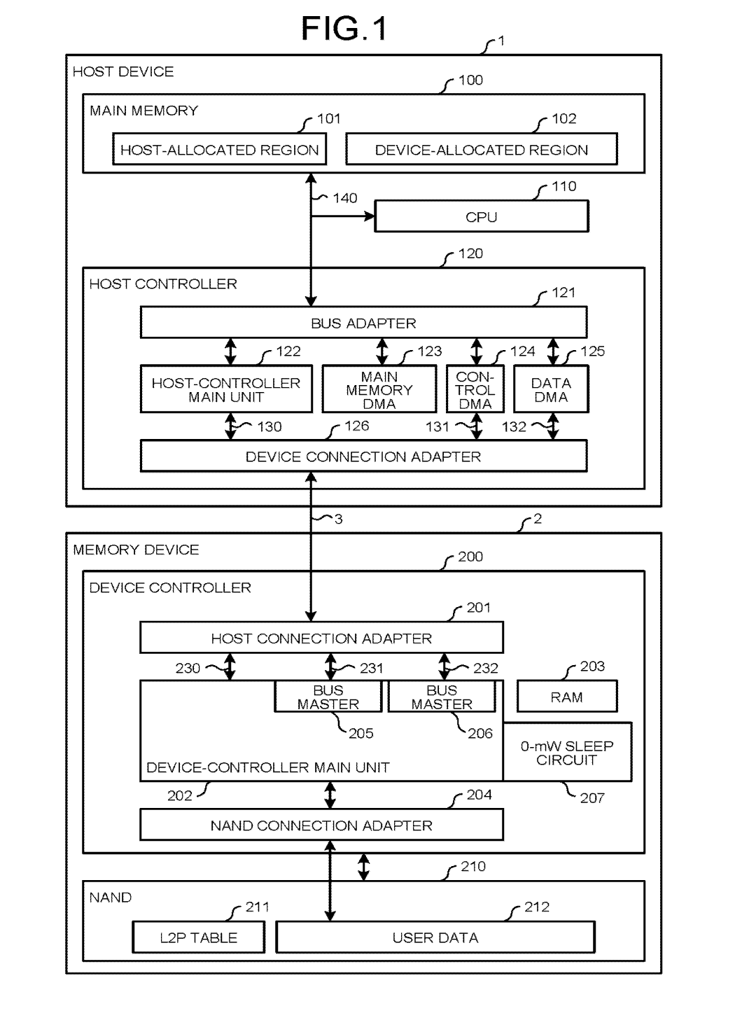

FIG. 1 is a diagram illustrating a basic configuration of an information processing device as described in the first embodiment. The information processing device according to the first embodiment includes a host device (hereinafter, “host”) 1 and a memory device (memory system) 2. The memory device 2 functions as an external storage device of the host 1.

The host 1 and the memory device 2 support a UMA (Unified Memory Architecture). In the information processing device, a memory (a main memory 100 described later) included in the host 1 is shared between the host 1 and the memory device 2.

The memory device 2 supports UME (Unified Memory Extension). The memory device 2 is a device such as an embedded flash memory conforming to the UFS (Universal Flash Storage) standard or an SSD (Solid State Drive). The host 1 is a device such as a personal computer, a mobile terminal, or an image capturing device.

The host 1 and the memory device 2 are mutually connected with each other via a communication path 3. As the communication standard of the communication path 3, for example, MIPI (Mobile Industry Processor Interface) M-PHY and UniPro are employed. The communication path 3 can employ any communication standard.

<Configuration of Memory Device>

The memory device 2 includes a NAND flash memory (hereinafter, “NAND”) 210 as a non-volatile memory that is a second memory, and a device controller 200 as a second controller circuit. The non-volatile memory is not limited to a NAND flash memory, but can be a three-dimensional structure flash memory, a ReRAM (Resistance Random Access Memory), or a FeRAM (Ferroelectric Random Access Memory), for example.

The NAND 210 includes one or more memory chips each having a memory cell array. The memory cell array includes a plurality of memory cells arrayed in a matrix. The NAND 210 deletes data on a block basis, where the block including a plurality of pages. A page is a minimum unit for reading and writing.

User data 212 transmitted from the host 1 and management information of the memory device 2 are stored in the NAND 210. FIG. 1 illustrates an L2P table 211 that is a logical-to-physical conversion table of the management information stored in the NAND 210. The NAND 210 also stores therein firmware that causes a device-controller main unit 202 as a main controller of the memory device 2 to operate.

The user data 212 includes, for example, an operating system program (OS) on which the host 1 provides an execution environment, a user program that is executed by the host 1 on the OS, and data input to and output from the OS or the user program.

The device controller 200 performs data transfer between the host 1 and the device controller 200. The device controller 200 includes a host connection adapter 201, a NAND connection adapter 204, the device-controller main unit 202, a RAM 203, and a 0 mW (zero milliwatt) sleep circuit 207.

The host connection adapter 201 is a connection interface for the communication path 3. The host connection adapter 201 functions as a host communication unit that performs communication with the host 1. The NAND connection adapter 204 is a connection interface for the NAND 210.

The RAM 203 is a volatile semiconductor memory that allows a higher-speed access than that of the NAND 210. An SRAM (Static Random Access Memory) or a DRAM (Dynamic Random Access Memory) is used as the RAM 203. The RAM 203 temporarily stores therein at least a portion of the firmware stored in the NAND 210.

The RAM 203 functions as a buffer used in data transfer between the NAND 210 and the host 1. The RAM 203 is also used as a command queue for queuing commands received from the host 1.

The RAM 203 temporarily stores therein user data and the management information of the memory device 2. The management information managed by the RAM 203 is backed up in the NAND 210. When the memory device 2 is activated, the firmware and the management information are read out from the NAND 210 and are loaded in the RAM 203.

The management information includes the L2P table 211 and a block management table, for example. Mapping of a logical address used in the host 1 and a physical address in the RAM 203 or a physical address in the NAND 210 is registered in the L2P table 211. As the logical address, LBA (Logical Block Addressing) is used, for example.

For example, the following information is registered in the block management table.
Number of deletions of each block
Use state (identification information whether it is an active block or a free block)
Identification information of bad block

An active block is a logical block in which valid data is recorded. A free block is a logical block having no valid data recorded therein and can be reused by deletion of its data. A bad block is a physical block that cannot normally operate due to various reasons and cannot be used.

The device-controller main unit 202 is a main controller of the memory device 2 and generally controls respective constituent elements of the memory device 2. The device-controller main unit 202 controls data transfer between the host 1 and the RAM 203 and data transfer between the RAM 203 and the NAND 210.

For example, the device-controller main unit 202 is a microcomputer unit including an arithmetic device such as a CPU (Central Processing Unit), and a storage device such as a ROM (Read Only Memory). The storage device stores therein a boot program that is operated when the memory device 2 is activated. The arithmetic device executes firmware loaded in the RAM 203 and the program stored in the storage device, thereby implementing the functions of the device-controller main unit 202.

In addition to the above elements, a peripheral circuit, a register, and the like for implementing the functions of the device controller 200 are incorporated in the device-controller main unit 202. The device-controller main unit 202 can be an ASIC (Application Specific Integrated Circuit).

The device-controller main unit 202 functions as a bus master in the communication path between the host 1 and the device-controller main unit 202. The device-controller main unit 202 performs data transfer by using a first port 230. The device-controller main unit 202 further includes two bus masters 205 and 206. The bus master 205 performs data transfer between the host 1 and the bus master 205 by using a second port 231. The bus master 206 performs data transfer between the host 1 and the bus master 206 by using a third port 232.

The 0-mW sleep circuit 207 controls an operation in a transition of the memory device 2 to an active mode and a 0-mW sleep mode. The 0-mW sleep circuit 207 is a microcomputer unit including an arithmetic device such as a CPU, and a storage device such as a ROM, for example. A resume program that is operated when the memory device 2 resumes from the 0-mW sleep mode is stored in the storage device. The arithmetic device executes the program stored in the storage device to implement the functions of the 0-mW sleep circuit 207.

Power is supplied to the memory device 2 from the outside of the memory device 2. The power supplied to the memory device 2 is supplied to each element in the memory device 2 via an internal power-supply line (not illustrated). Note that the memory device 2 can include an internal power supply.

<Configuration of Host>

The host 1 includes a CPU 110 that executes an OS and a user program, the main memory 100, and a host controller 120 as a first controller circuit. The main memory 100, the CPU 110, and the host controller 120 are mutually connected with one another via a bus 140.

The main memory 100 is formed by a DRAM, for example. The main memory 100 includes a host-allocated region 101 and a device-allocated region 102 that is a Unified Memory (hereinafter, “UM”). The host-allocated region 101 is used as a program developing region when the host 1 executes the OS and the user program. Also, the host-allocated region 101 is used as a work area when a program developed in the program developing region is executed.

The UM 102 as a first memory is a region allocated to a device that is connected to the host 1. The UM 102 is used as an area for saving information of the memory device 2 during a period in which the memory device 2 is in the 0-mW sleep mode. The UM 102 is also used as a cache region for data to be read and written.

The host controller 120 includes a bus adapter 121, a host-controller main unit 122, and a device connection adapter 126. The device connection adapter 126 is a connection interface for the communication path 3. The bus adapter 121 is a connection interface for the bus 140.

The host-controller main unit 122 performs transfer of data (including commands) between the main memory 100 or the CPU 110 and the host-controller main unit 122 via the bus adapter 121. The first port 130 connects the host-controller main unit 122 and the device connection adapter 126. The host-controller main unit 122 performs transfer of data (including commands) between the memory device 2 and the host-controller main unit 122 via the first port 130 and the device connection adapter 126.

The host-controller main unit 122 includes a main memory DMA (Dynamic Memory Access) 123, a control DMA 124, and a data DMA 125. The main memory DMA 123 performs DMA transfer between the host-allocated region 101 and the UM 102.

The second port 131 connects the control DMA 124 and the device connection adapter 126. The control DMA 124 captures a command that is transmitted by the memory device 2 for making an access to the UM 102, and transfers the captured command to the host-controller main unit 122 or the main memory DMA 123. The control DMA 124 transmits status information regarding the access to the UM 102 to the memory device 2. The control DMA 124 transmits and receives commands and the status information to and from the memory device 2 via the second port 131 and the device connection adapter 126.

The third port 132 connects the data DMA 125 and the device connection adapter 126. The data DMA 125 performs DMA transfer between the UM 102 and the memory device 2. The data DMA 125 performs data transfer between the memory device 2 and the data DMA 125 via the third port 132 and the device connection adapter 126.

The first port 130 and the first port 230 are associated with each other by the functions of the device connection adapter 126 and the host connection adapter 201. The contents transmitted from the host-controller main unit 122 to the device connection adapter 126 through the first port 130 are transmitted from the host connection adapter 201 to the device-controller main unit 202 through the first port 230. The contents transmitted from the device-controller main unit 202 to the host connection adapter 201 through the first port 230 are transmitted from the device connection adapter 126 to the host-controller main unit 122 through the first port 130.

Similarly to the case of the first ports 130 and 230, the second port 131 and the second port 231 are associated with each other. The contents transmitted from the control DMA 124 to the device connection adapter 126 through the second port 131 are transmitted from the host connection adapter 201 to the device-controller main unit 202 through the second port 231. The contents transmitted from the device-controller main unit 202 to the host connection adapter 201 through the second port 231 are transmitted from the device connection adapter 126 to the control DMA 124 through the second port 131. The contents transmitted to the control DMA 124 are transmitted to the host-controller main unit 122 through the bus adapter 121.

Similarly to the case of the first ports 130 and 230, the third port 132 and the third port 232 are associated with each other. The contents transmitted from the data DMA 125 to the device connection adapter 126 through the third port 132 are transmitted from the host connection adapter 201 to the device-controller main unit 202 through the third port 232. The contents transmitted from the device-controller main unit 202 to the host connection adapter 201 through the third port 232 are transmitted from the device connection adapter 126 to the data DMA 125 through the third port 132. The contents transmitted to the data DMA 125 are transmitted to the host-controller main unit 122 through the bus adapter 121.

Each of the ports 130, 131, and 132 has a unique input/output buffer used for communication with the memory device 2. The host-controller main unit 122, the control DMA 124, and the data DMA 125 are respectively connected to the memory device 2 by using their unique input/output buffer. Due to this configuration, the host controller 120 can independently perform communications with the memory device 2 each using one of the host-controller main unit 122, the control DMA 124, and the data DMA 125.

The host controller 120 can switch these communications without switching input/output buffers, and therefore the communications can be switched at a high speed. Similarly, the device controller 200 can switch communications using the ports 230, 231, and 232 of the memory device 2 at a high speed.

Basically, the information processing device uses the first ports 130 and 230 when a request from the host 1 to the memory device 2 is issued. The information processing device uses the second ports 131 and 231 and the third ports 132 and 232 at the time of transmitting information to be saved from the memory device 2 into the host 1.

<State Transition of Memory Device>

Next, a transition of states of the memory device 2 is described. The memory device 2 transitions between a plurality of states including an active mode in which the memory device 2 can perform a normal operation and a sleep mode as a standby power mode, which is a power saving mode.

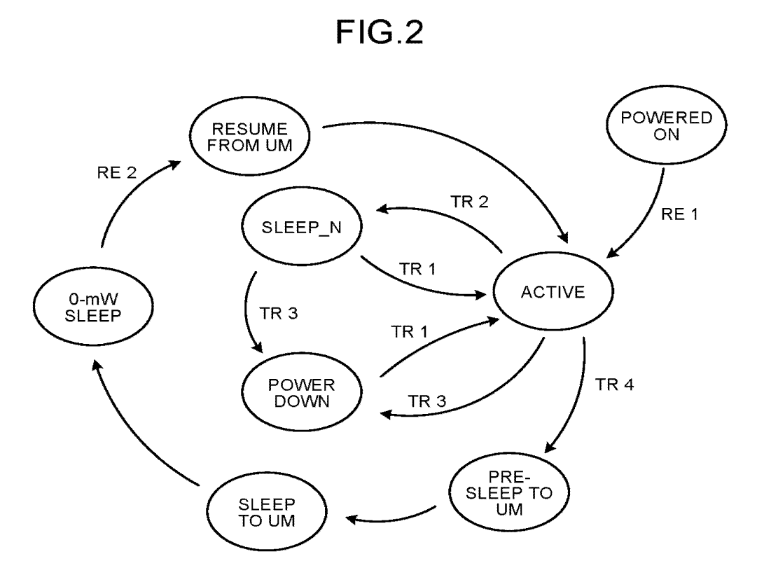

FIG. 2 is a diagram illustrating an example of a state transition of the memory device 2. The memory device 2 transitions between a plurality of modes, so that it can reduce power consumption in accordance with its operation status. FIG. 2 illustrates an example of a transition between modes that are a part of a plurality of modes supported by the memory device 2.

As the power of the memory device 2 is turned on in a power-off state, the memory device 2 is in a powered-on mode (POWERED ON). The host 1 issues a resume command “RE1” (a first command). “RE1” is assumed to be a resume command issued in a case of requesting a process (first process) of resuming from the powered-on mode to the active mode. An fDeviceInit flag is set in the first command “RE1”. The device controller 200 acquires the fDeviceInit flag that is information indicating resuming from the powered-on mode, and performs a process of resuming from the powered-on mode.

When the device controller 200 receives “RE1” from the host 1, the device-controller main unit 202 initializes the memory device 2 by power-on reset. The memory device 2 executes a boot program and transitions from the powered-on mode to the active mode (ACTIVE) (first state). The memory device 2 is operated in accordance with a command in the active mode.

The host 1 issues a transition command to request a transition of the mode of the memory device 2. The transition command is a state management command for the memory device 2, and it is an SSU (Start Stop Unit) command, for example. The memory device 2 transitions from the active mode to another mode in accordance with the transition command received from the host 1.

The memory device 2 reduces its power consumption by transitioning from the active mode to the sleep mode. The sleep mode, to which the memory device 2 can transition from the active mode, includes a normal sleep mode (SLEEP_N) and a 0-mW sleep mode (0 mW SLEEP) (second state).

The normal sleep mode is a sleep mode other than the 0-mW sleep mode among the sleep modes supported by the memory device 2. In the normal sleep mode, power supply to at least a part of the RAM 203 is stopped, for example. In the normal sleep mode, it is also possible that power supply to the NAND 210 is stopped. In the normal sleep mode, power supply to the memory device 2 that enables a transition to the active mode in accordance with a command from the host 1 is continued.

The 0-mW sleep mode is one of the sleep modes supported by the memory device 2. In the 0-mW sleep mode, power supply to the memory device 2 is stopped. Also, power supply to the memory device 2 that enables the transition to the active mode in accordance with the command from the host 1 is stopped in the 0-mW sleep mode.

A power-down mode (POWER DOWN) is one of modes from which the memory device 2 can transition to the active mode in accordance with a command from the host 1, with minimum power consumption. In the power-down mode, power supply to the memory device 2 enabling a transition to the active mode in accordance with a command from the host 1 is continued.

The host 1 issues a transition command including information indicating the mode to which a transition is requested. The information indicating the mode is stored in a predetermined field in the transition command.

In the present embodiment, “TR1” is assumed to be a transition command issued in a case of requesting a transition from an arbitrary mode to the active mode. “TR2” is assumed to be a transition command issued in a case of requesting a transition from an arbitrary mode to the normal sleep mode. “TR3” is assumed to be a transition command issued in a case of requesting a transition from an arbitrary mode to the power-down mode. “TR4” is assumed to be a transition command issued in a case of requesting a process (third process) for a transition from the active mode to the 0-mW sleep mode.

When the device controller 200 receives “TR2” in the active mode, the device-controller main unit 202 performs a process of a transition to the normal sleep mode. The device-controller main unit 202 stores setting data in an operation in the active mode in the NAND 210. When “TR1” is received in a preparation step for a transition to the normal sleep mode, the device-controller main unit 202 can perform a process of a transition to the active mode.

When the device controller 200 receives “TR3” in the active mode or the normal sleep mode, the device-controller main unit 202 performs a process of a transition to the power-down mode. In a case where “TR1” is received in a preparation step for a transition to the power-down mode, the device-controller main unit 202 can perform the process of a transition to the active mode.

When the device controller 200 receives “TR1” in the normal sleep mode or the power-down mode, the device-controller main unit 202 performs the process of a transition to the active mode.

When the device controller 200 receives “TR4” in the active mode, the 0-mW sleep circuit 207 performs a process of a transition to the 0-mW sleep mode. “PRE-SLEEP TO UM” represents a state where the device controller 200 is performing a process being performed at a time of reception of “TR4”. When this process is completed, the 0-mW sleep circuit 207 instructs transmission of save data to the UM 102.

The save data is internal data set in the device controller 200 at a time of the request for a transition to the 0-mW sleep mode, and the save data is used in resuming to the active mode. The internal data includes status information regarding an operation state of the memory device 2 and management information of the memory device 2.

“SLEEP TO UM” is assumed to be a state where the device controller 200 is writing the save data to the UM 102 in accordance with the instruction from the 0-mW sleep circuit 207. When writing of the save data to the UM 102 is completed, power supply to the memory device 2 is stopped. Due to this process, the memory device 2 transitions to the 0-mW sleep mode.

When the power of the memory device 2 in the 0-mW sleep mode is turned on, the host 1 issues a resume command “RE2”. “RE2” is assumed to be a resume command issued in a case of requesting a resume process from the 0-mW sleep mode to the active mode (second process). In “RE2” as a second command, an fDeviceResume flag is set instead of the fDeviceInit flag in “RE1”, which is the first command. The device controller 200 acquires the fDeviceResume flag that is information indicating resuming from the 0-mW sleep mode, and performs the resume process from the 0-mW sleep mode.

When the device controller 200 receives “RE2” from the host 1 in the 0-mW sleep mode, the 0-mW sleep circuit 207 executes a resume program and starts a process of a transition to the active mode. “Resume From UM” represents a state where reading of the save data from the UM 102 is being prepared. The device controller 200 reads out the save data from the UM 102 in accordance with an instruction from the 0-mW sleep circuit 207. The device-controller main unit 202 stores the read save data in the RAM 203.

In this manner, the device controller 200 recognizes that initialization by power-on reset is requested, in a case where the resume command when the power is turned on is “RE1” (the first command). The device-controller main unit 202 performs a power-on reset process.

The device controller 200 recognizes that resuming from the 0-mW sleep mode is requested, in a case where the resume command when the power is turned on is “RE2” (the second command). The 0-mW sleep circuit 207 performs the process of resuming from the 0-mW sleep mode.

The device controller 200 identifies the first command and the second command based on the information of the fDeviceInit flag and the information of the fDeviceResume flag included in the first command and the second command.

The device controller 200 recognizes that a transition to the 0-mW sleep mode is requested, in a case where “TR4” (a third command) is received in the request for power off. The 0-mW sleep circuit 207 performs the process of a transition to the 0-mW sleep mode.

The device controller 200 recognizes that normal power-off that does not involve storing the save data in the UM 102 is requested, in a case where “TR4” (the third command) is not received in the request for power off. The device-controller main unit 202 performs a process of turning off the memory device 2.

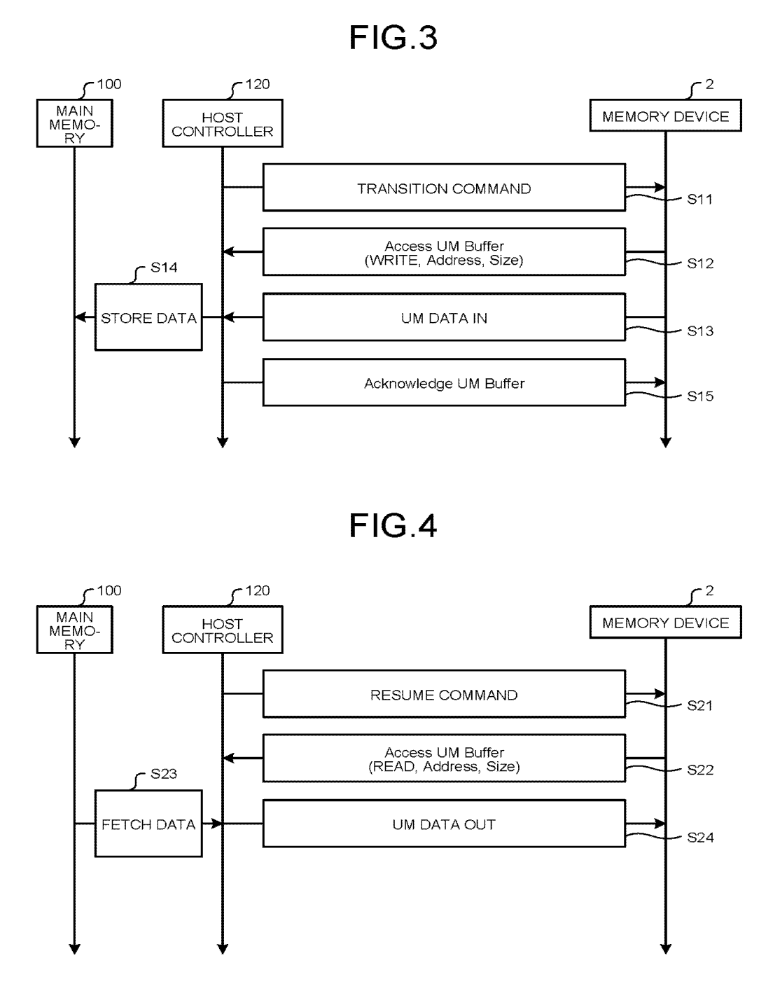

FIG. 3 is a diagram illustrating an operation example of the information processing device in the case of the memory device 2 transitioning from active mode to 0-mW sleep mode. In the present embodiment, the memory device 2 performs a state transition in accordance with a request from the host 1.

The host controller 120 transmits the “TR4” (the third command) mentioned above, which is a transition command, to the memory device 2 (S11). When the device controller 200 receives this transition command, the 0-mW sleep circuit 207 generates a command (Access UM Buffer) that instructs writing of save data into the UM 102.

This command (Access UM Buffer) includes information such as a write command (WRITE), an address of a region into which save data is written, and information regarding the data size of the save data, and also includes information of a port used for transmitting the save data. The 0-mW sleep circuit 207 transmits this command (Access UM Buffer) to the host controller 120 via the host connection adapter 201 (S12). In response to this transmission, the 0-mW sleep circuit 207 instructs the host 1 to write the save data into the UM 102.

The device controller 200 transmits the save data (UM DATA IN) to the host controller 120 via the host connection adapter 201 in accordance with the instruction of the 0-mW sleep circuit 207 (S13). In this manner, the 0-mW sleep circuit 207 performs a process of making the memory device 2 transition to the 0-mW sleep mode in response to the reception of the third command “TR4”.

The host controller 120 receives the save data (UM DATA IN) from the memory device 2 based on the received command (Access UM Buffer). The host controller 120 stores the received save data (UM DATA IN) in the UM 102 (S14).

When the save data (UM DATA IN) is stored in the UM 102, the host controller 120 transmits a response command (Acknowledge UM Buffer) indicating completion of writing to the memory device 2 (S15). With this transmission, the memory device 2 completes writing of the save data into the host 1.

FIG. 4 is a diagram illustrating an operation example of the information processing device in the case of the memory device 2 transitioning from 0-mW sleep mode to active mode.

The host controller 120 transmits “RE2” (the second command) as the resume command to the memory device 2 (S21). The fDeviceResume flag is set in this resume command. When the device controller 200 receives this resume command, the 0-mW sleep circuit 207 generates a command (Access UM Buffer) that instructs fetching (reading) of save data from the UM 102.

This command (Access UM Buffer) includes information such as a read command (READ), an address of a region from which save data is read out, and information regarding the data size of the save data, and also includes information of a port used for reading out the save data. The 0-mW sleep circuit 207 transmits this command (Access UM Buffer) to the host controller 120 via the host connection adapter 201 (S22). In this manner, the 0-mW sleep circuit 207 issues a request for reading out the save data in response to reception of the second command “RE2”.

The host controller 120 fetches the save data from the UM 102 based on the received command (Access UM Buffer) (S23). The host controller 120 transfers the fetched save data (UM DATA OUT) to the memory device 2 (S24). The memory device 2 receives the save data transferred from the host controller 120.

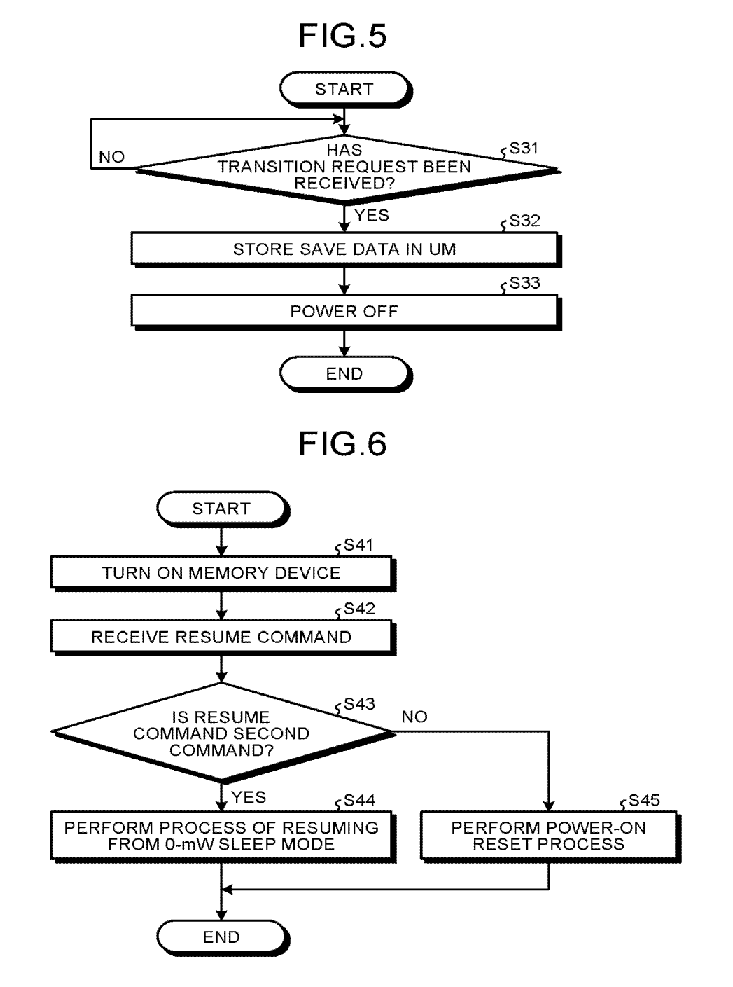

FIG. 5 is a flowchart illustrating an operation procedure of the memory device 2 when the memory device 2 transitions to 0-mW sleep mode. When the host connection adapter 201 receives the transition command “TR4” that is a request for a transition to the 0-mW sleep mode (YES at S31), the 0-mW sleep circuit 207 stores save data in the UM 102 in accordance with the procedure illustrated in FIG. 3 (S32).

When storing of the save data in the UM 102 is completed, the 0-mW sleep circuit 207 requests turning off of power supply to respective elements in the memory device 2. The power supply to the memory device 2 is then turned off (S33). This process completes a transition of the memory device 2 from the active mode to the 0-mW sleep mode. The information processing device can turn off all the power supply of the memory device 2 without writing internal data into the NAND 210.

FIG. 6 is a flowchart illustrating an operation procedure of the memory device 2 when a resume request is issued. When the power of the memory device 2 is turned on (S41), the host 1 transmits a resume command to the memory device 2. The memory device 2 receives the resume command (S42).

In a case where the resume command received in the memory device 2 is “RE2” that is the second command (YES at S43), the device controller 200 recognizes that the resume request is a resume request from the 0-mW sleep mode. The fDeviceResume flag is set in “RE2”. The 0-mW sleep circuit 207 performs a process of resuming from the 0-mW sleep mode based on this resume command (S44).

The 0-mW sleep circuit 207 reads out save data from the UM 102 in accordance with the procedure illustrated in FIG. 4. The 0-mW sleep circuit 207 re-stores information such as the read save data in the RAM 203. By the re-storing of the read save data, the memory device 2 resumes to an operation state before transitioning to the 0-mW sleep mode. This process completes a transition of the memory device 2 from the 0-mW sleep mode to the active mode.

Meanwhile, in a case where the resume command received in the memory device 2 is “RE1” that is the first command (NO at S43), the device controller 200 recognizes that the transition request received from the host 1 is a request for a transition from the powered-on mode. The fDeviceInit flag is set in the “RE1”. The device-controller main unit 202 performs a power-on reset process (S45). The device-controller main unit 202 initializes the memory device 2 and makes the memory device 2 transition to the active mode.

The save data stored in the UM 102 can include elements such as firmware to be loaded in the RAM 203 or user data stored in the RAM 203 at a time of a transition to the sleep mode.

According to the first embodiment, as the power supply to the memory device 2 is stopped in the 0-mW sleep mode, its power consumption can be reduced. The memory device 2 saves the internal data in the device controller 200 to the UM 102 in the 0-mW sleep mode. The memory device 2 does not require writing of the internal data to the NAND 210 when transitioning to the 0-mW sleep mode. Due to this configuration, the number of accesses to the NAND 210 can be reduced, resulting in a longer lifetime of the NAND 210. The device controller 200 can clearly distinguish the request for initialization by power-on reset and the request for resuming from the 0-mW sleep mode from each other based on the first command and the second command that are resuming requests.

### Second Embodiment

An information processing device according to a second embodiment has a basic configuration identical to that of the information processing device according to the first embodiment. Descriptions of the second embodiment redundant to those of the first embodiment are omitted as appropriate.

The device controller 200 distinguishes a request for initialization by power-on reset and a request for resuming from a 0-mW sleep mode based on flags in the first and second commands.

When requesting initialization by power-on reset, the host 1 issues a resume command “RE1” (the first command). When resuming from a 0-mW sleep mode is requested, the host 1 issues a resume command “RE2” (the second command).

An fDeviceInit flag of “1” is set in “RE1”. The fDeviceInit flag of “0” and an fDeviceResume flag of “1” are set in “RE2”.

The device controller 200 reads the fDeviceInit flag in the resume command received from the host 1. In a case where the fDeviceInit flag is “1”, the device controller 200 recognizes this resume command as the first command “RE1”. The device controller 200 acquires the fDeviceInit flag of “1” that is information indicating resuming from a powered-on mode, and performs a process of resuming from the powered-on mode.

When the fDeviceInit flag is “0”, the device controller 200 reads the fDeviceResume flag in the resume command. When the fDeviceResume flag is “1”, the device controller 200 recognizes that resume command as the second command “RE2”. The device controller 200 acquires the fDeviceResume flag of “1” that is information indicating resuming from the 0-mW sleep mode, and performs a process of resuming from the 0-mW sleep mode.

According to the second embodiment, the device controller 200 can clearly distinguish a request for initialization by power-on reset and the request for resuming from the 0-mW sleep mode from each other based on the flags in the first and second commands.

### Third Embodiment

An information processing device according to a third embodiment has a basic configuration identical to that of the information processing device according to the first embodiment. Descriptions of the third embodiment redundant to those of the first embodiment are omitted as appropriate.

The host 1 checks whether save data is stored in the UM 102 and notifies the memory device 2 of a check result. The memory device 2 distinguishes a request for initialization by power-on reset and a request for resuming from a 0-mW sleep mode from each other based on the check result, instead of the first and second commands. The device controller 200 acquires a check result indicating that no save data is stored, as information indicating resuming from a powered-on mode, and performs a process of resuming from the powered-on mode. The device controller 200 acquires the check result indicating that save data is stored, as information indicating resuming from the 0-mW sleep mode, and performs a process of resuming from the 0-mW sleep mode.

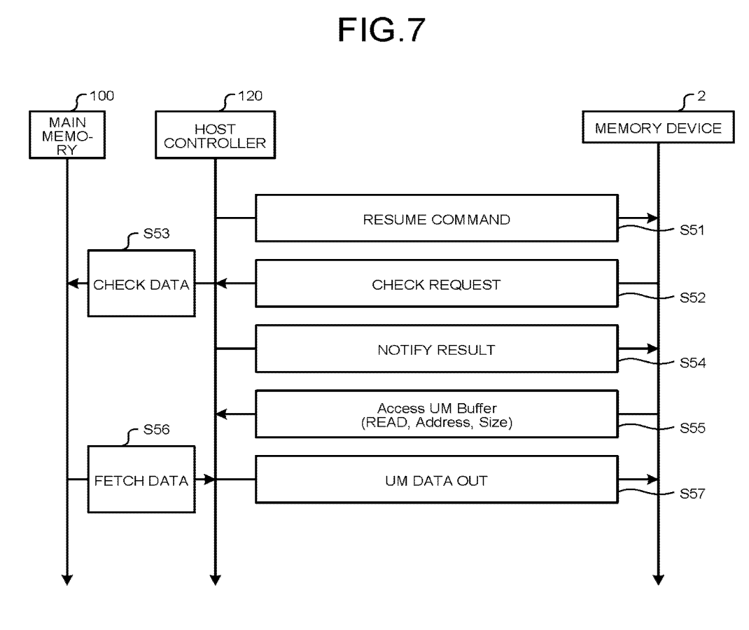

FIG. 7 is a diagram illustrating an operation example of the information processing device where the memory device 2 transitions from 0-mW sleep mode to active mode.

The host controller 120 transmits a resume command to the memory device 2 (S51). Upon reception of this resume command, the device controller 200 requests the host 1 to check whether save data is stored in the UM 102 (S52).

The host controller 120 checks whether any data is stored in the UM 102 in response to the check request from the memory device 2 (S53). The host controller 120 notifies the memory device 2 of the check result (S54).

In a case of resuming from the 0-mW sleep mode, save data is stored in the UM 102. The host controller 120 transmits the check result indicating that the save data is stored in the UM 102 to the memory device 2. When the device controller 200 receives this check result, the 0-mW sleep circuit 207 generates a command (Access UM Buffer) that instructs fetching (reading) of the save data from the UM 102. The 0-mW sleep circuit 207 transmits this command (Access UM Buffer) to the host controller 120 via the host connection adapter 201 (S55).

The host controller 120 fetches the save data from the UM 102 based on the received command (Access UM Buffer) (S56). The host controller 120 transfers the fetched save data (UM DATA OUT) to the memory device 2 (S57). The memory device 2 receives the save data transferred from the host controller 120.

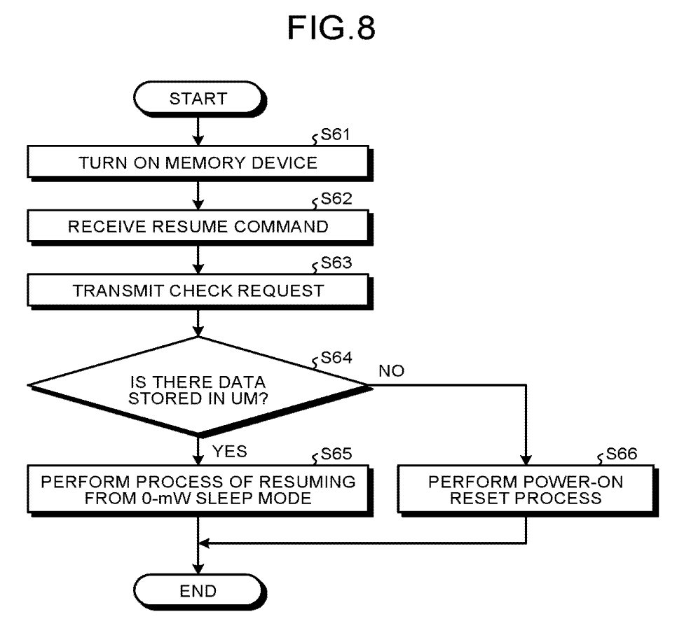

FIG. 8 is a flowchart illustrating an operation procedure of the memory device 2 when a resume request is issued. When the power of the memory device 2 is turned on (S61), the host 1 transmits a resume command to the memory device 2. The memory device 2 receives the resume command (S62).

Upon reception of the resume command, the device controller 200 transmits a request for checking whether save data is stored in the UM 102 to the host 1 (S63). In a case where the device controller 200 receives a check result indicating that the save data is stored in the UM 102 from the host 1 (YES at S64), the device controller 200 recognizes that the resume request is a request for resuming from the 0-mW sleep mode. The 0-mW sleep circuit 207 performs a process of resuming from the 0-mW sleep mode based on that check result (S65).

Meanwhile, in a case where the device controller 200 has received a check result indicating that save data is not stored in the UM 102 from the host 1 (NO at S64), the device controller 200 recognizes that a transition request received from the host 1 is a request for a transition from a powered-on mode. The device-controller main unit 202 performs a power-on reset process based on this check result (366).

According to the third embodiment, the device controller 200 receives the check result indicating whether the save data is stored in the UM 102 from the host 1. The device controller 200 can clearly distinguish a request for initialization by power-on reset and the request for resuming from the 0-mW sleep mode from each other based on the check result.

### Fourth Embodiment

An information processing device according to a fourth embodiment has a basic configuration identical to that of the information processing device according to the first embodiment. Descriptions of the fourth embodiment redundant to those of the first embodiment are omitted as appropriate.

When transmitting a resuming request to the memory device 2, the host 1 transmits, to the memory device 2, an identification signal indicating whether the resuming is from a 0-mW sleep mode. The memory device 2 distinguishes a request for initialization by power-on reset and a request for resuming from the 0-mW sleep mode based on this identification signal, instead of the first and second commands. The device controller 200 acquires the identification signal as information indicating resuming from the 0-mW sleep mode, and performs a process of resuming from the 0-mW sleep mode.

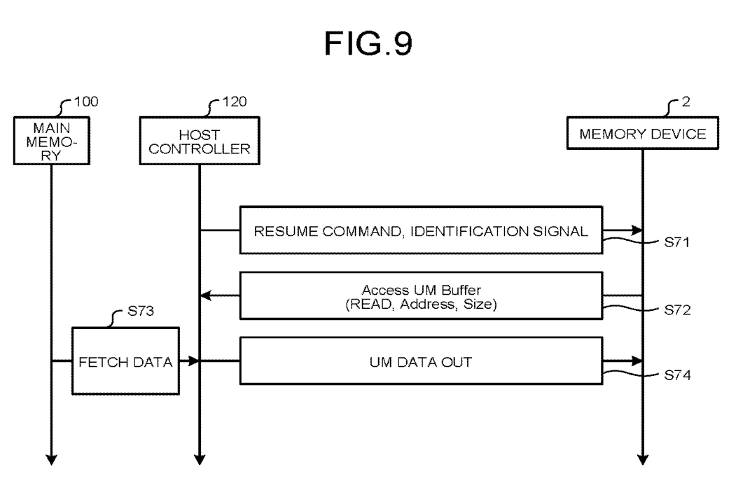

FIG. 9 is a diagram illustrating an operation example of the information processing device where the memory device 2 transitions from 0-mW sleep mode to active mode.

The host controller 120 transmits a resume command and an identification signal to the memory device 2 (S71). The host controller 120 has information whether the state of the memory device 2 is the 0-mW sleep mode. The device connection adapter 126 transmits the identification signal to the memory device 2 by using an existing signal line in the communication path 3. A signal line for transmission of the identification signal can be added in the communication path 3. The identification signal can be any signal from which it can be identified by the memory device 2 whether the resuming is from the 0-mW sleep mode.

When the device controller 200 receives the identification signal indicating resuming from the 0-mW sleep mode together with the resume command, the 0-mW sleep circuit 207 generates a command (Access UM Buffer). The 0-mW sleep circuit 207 transmits this command (Access UM Buffer) to the host controller 120 via the host connection adapter 201 (S72).

The host controller 120 fetches save data from the UM 102 based on the received command (Access UM Buffer) (S73). The host controller 120 transfers the fetched save data (UM DATA OUT) to the memory device 2 (S74). The memory device 2 receives the save data transferred from the host controller 120.

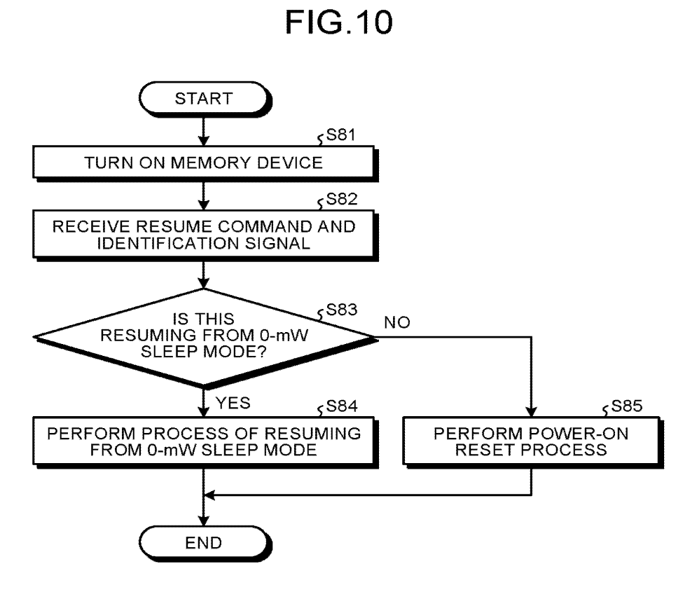

FIG. 10 is a flowchart illustrating an operation procedure of the memory device 2 when a resume request is issued. When the power of the memory device 2 is turned on (S81), the host 1 transmits a resume command and an identification signal to the memory device 2. The memory device 2 receives the resume command and the identification signal (S82).

Upon reception of the identification signal indicating resuming from the 0-mW sleep mode together with the resume command (YES at S83), the device controller 200 recognizes that the resume request is a request for resuming from the 0-mW sleep mode. The 0-mW sleep circuit 207 performs a process of resuming from the 0-mW sleep mode (S84).

Meanwhile, if the device controller 200 has not received the identification signal indicating resuming from the 0-mW sleep mode (NO at S83), the device controller 200 recognizes that the request is not for resuming from the 0-mW sleep mode. The device controller 200 then recognizes that the request is for a transition from a powered-on mode. The device-controller main unit 202 performs a power-on reset process (S85).

According to the fourth embodiment, the device controller 200 receives an identification signal indicating whether the resuming is from a 0-mW sleep mode from the host 1. The device controller 200 can clearly distinguish a request for initialization by power-on reset and a request for resuming from the 0-mW sleep mode from each other based on this identification signal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device that can be connected to a host device including a first memory, the memory device comprising:
a second memory that is a non-volatile memory; and
a controller circuit configured to perform a first process of initializing the memory device and making the memory device transition to a first state and a second process of making the memory device transition from a second state to the first state, power supply to the memory device being stopped in the second state, internal data of the controller circuit being saved in the second state in the first memory, wherein
the controller circuit acquires information indicating resuming from the second state from the host device, to perform the second process.

2. The memory device according to claim 1, wherein the controller circuit performs the first process in accordance with a first command and performs the second process in accordance with a second command.

3. The memory device according to claim 2, wherein the controller circuit identifies the first command and the second command based on information of flags included in the first command and the second command.

4. The memory device according to claim 1, wherein the controller circuit issues a request for checking whether internal data is stored in the first memory, and acquires a check result indicating that the internal data is stored to perform the second process.

5. The memory device according to claim 1, wherein the controller circuit acquires an identification signal indicating resuming from the second state to perform the second process.

6. The memory device according to claim 1, wherein the controller circuit issues a request for checking whether internal data is stored in the first memory, and acquires a check result indicting that internal data is not stored to perform the first process.

7. The memory device according to claim 1, wherein the second process includes issuing a request for reading out internal data from the first memory.

8. The memory device according to claim 1, wherein the controller circuit issues a request for writing internal data into the first memory in a third process in which the memory device is made to transition from the first state to the second state.

9. The memory device according to claim 2, wherein the controller circuit performs a third process of making the memory device transition from the first state to the second state in accordance with a third command.

10. The memory device according to claim 1, wherein the controller circuit identifies a request for the first process and a request for the second process based on information from the host device.

11. A host device that is connectable with a memory device, the host device comprising:
a controller circuit configured to issue a request for a first process of initializing the memory device and making the memory device transition to a first state and a request for a second process of making the memory device transition from a second state to the first state, power supply to the memory device being stopped in the second state; and
a memory configured to store therein internal data of the memory device when the memory device is in the second state, wherein
the controller circuit transmits information indicating resuming from the second state in the request for the second process.

12. The host device according to claim 11, wherein the controller circuit transmits information allowing the request for the first process and the request for the second process to be identified.

13. The host device according to claim 11, wherein the controller circuit issues a first command that is the request for the first process and a second command that is the request for the second process.

14. The host device according to claim 13, wherein the first command and the second command include flags for identifying the first command and the second command.

15. The host device according to claim 11, wherein the controller circuit issues a check result indicating whether internal data is stored in the memory in response to a request from the memory device.

16. The host device according to claim 11, wherein the controller circuit outputs an identification signal indicating whether resuming is from the second state.

17. The host device according to claim 13, wherein the controller circuit issues a third command requesting a third process of making the memory device transition from the first state to the second state.

18. An information processing device comprising:
a host device; and
a memory device that is connectable with the host device,
the host device including
a first controller circuit configured to issue a request for a first process of initializing the memory device and making the memory device transition to a first state and a request for a second process of making the memory device transition from a second state to the first state, power supply to the memory device being stopped in the second state, and
a first memory configured to store therein internal data of the memory device when the memory device is in the second state,
the memory device including
a second memory that is a non-volatile memory, and
a second controller circuit configured to perform the first process and the second process, wherein
the second controller circuit acquires information indicating resuming from the second state from the first controller circuit to perform the second process.

19. The information processing device according to claim 18, wherein the first controller circuit transmits information allowing the request for the first process and the request for the second process to be identified to the second controller circuit.

20. The information processing device according to claim 18, wherein the first controller circuit issues a first command that is the request for the first process and a second command that is the request for the second process.
